(19) United States
(12) Patent Application Publication
(10) Pub. No.: US 2001/0026148 A1
(43) Pub. Date: Oct. 4, 2001

(54) Reference power supply apparatus

(75) Inventor: Okuhito Saitou, Sagamihara-shi (JP)

Correspondence Address: LAFF, WHITESEL & SARET, LTD., Attorneys at Law, 401 North Michigan Avenue, Chicago, IL, 60611, US

(73) Assignee: Toei Electric Co., Ltd.

(21) Appl. No.: 09/809,569

(22) Filed: Mar. 15, 2001

(30) Foreign Application Priority Data
Mar. 28, 2000 (JP) 2000-088719

(51) Int. Cl. G05F 1/40

(52) U.S. Cl. 323/281

(57) ABSTRACT

There is disclosed a reference power supply apparatus comprising two resistors R1, R2 connected in series with each other between a reference level line, and a terminal to which a voltage having a predetermined level difference E from the reference level line is applied. Moreover, a division circuit is used to divide a voltage E between the opposite ends of two resistors R1, R2 by a voltage Vi between the opposite ends of the resistor R2, and a reference voltage Vo corresponding to a ratio of a resistance value of the resistor R1 to that of the resistor R2 is obtained.

### CROSS-REFERENCE TO RELATED APPLICATIONS

This application is based upon and claims the benefit of priority from the prior Japanese Patent Application No. 2000-088719, filed Mar. 28, 2000, the entire contents of which are incorporated herein by reference.

### BACKGROUND OF THE INVENTION

The present invention relates to a reference power supply apparatus for obtaining a stabilized reference voltage.

As is known, in order to obtain a stabilized reference voltage, a battery has heretofore been used, but a battery power is inevitably consumed. Therefore, the battery needs to be, for example, periodically changed or charged, and a problem occurs that it is troublesome for a user to handle the battery.

On the other hand, since development of Zener diode, a constitution in which the reference voltage is obtained by the Zener diode has been a mainstream. However, the Zener diode has a disadvantage that precision (particularly temperature characteristics) or the obtained reference voltage is determined by a diode composition (silicon semiconductor).

### BRIEF SUMMARY OF THE INVENTION

The present invention has been developed in consideration of the aforementioned situations, and an object thereof is to provide a reference power supply apparatus in which a stabilized arbitrary reference voltage can easily be obtained with high precision.

According to the present invention, there is provided a reference power supply apparatus comprising: a resistance element to which a voltage is applied; and a voltage generator for obtaining a reference voltage corresponding to a resistance value of the resistance element based on the voltage applied to the resistance element.

Here, first and second resistors connected in series with each other are used as the resistance element, and the voltage is applied between the opposite ends of the first and second resistors. A generator for generating the reference voltage corresponding to a ratio of the resistance value of the first resistor to the resistance value of the second resistor based on the voltage applied between the opposite ends of the first and second resistors is used as the voltage generator.

Moreover, in the voltage generator, the reference voltage to be outputted can be changed by changing the resistance values of the first and second resistors. In concrete terms, a division circuit for dividing the voltage applied between the opposite ends of the first and second resistors by the voltage applied to the opposite ends of the second resistor is used as the voltage generator.

According to the aforementioned constitution, a conventional problem caused by using the battery or the zener diode is solved, and the stabilized arbitrary reference voltage can easily be obtained with high precision.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing one embodiment of a reference power supply apparatus according to the present invention; and

FIG. 2 is a block diagram showing a modified example of the embodiment.

### DETAILED DESCRIPTION OF THE INVENTION

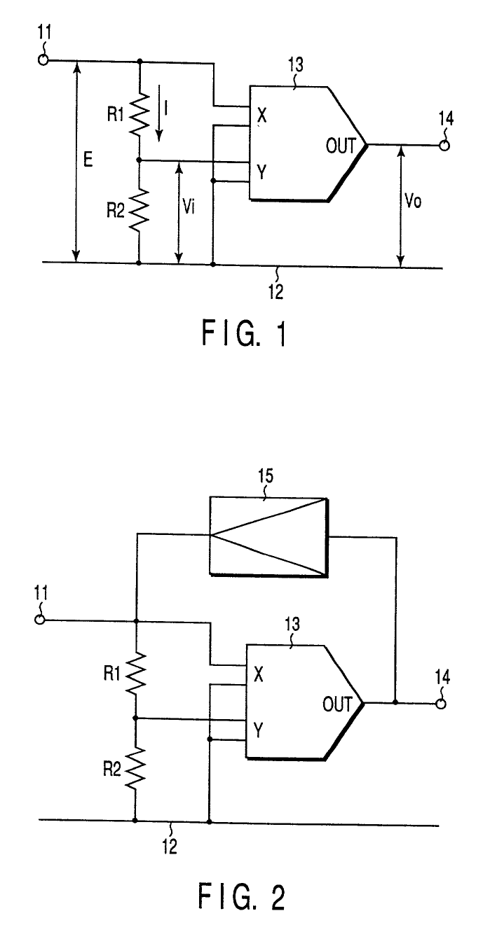

One embodiment of the present invention will be described hereinafter in detail with reference to the drawings. In FIG. 1, reference numeral 11 is a terminal. A series circuit constituted by connecting two resistors R1, R2 in series with each other is connected between the terminal 11 and a reference level line 12, and a voltage E is applied to the opposite ends of the series circuit.

The voltage E between the terminal 11 and the reference level line 12 is applied to a divided number input terminal X of a division circuit 13 as voltage generation means. Moreover, a voltage Vi between the opposite ends of the resistor R2 is applied to a divisor input terminal Y of the division circuit 13.

Furthermore, a stabilized reference voltage Vo is obtained between a terminal 14 connected to an output terminal OUT of the division circuit 13, and the reference level line 12.

That is, when the voltage E is applied to the resistors R1, R2 connected in series with each other, a current I flows through the resistors R1, R2.

E/(R1+R2)=I (1)

Equation (1) is changed to the following equation.

(E/I)=R1+R2 (2)

Here, if values of the resistors R1, R2 do not fluctuate, the equation (2) turns to the following equation.

(E/I)=R1+R2=constant (3)

When an output is obtained with the voltage in the electric division circuit 13, the values of the resistors R1, R2 are converted to a voltage output, and the output can be extracted.

In this case, resistors whose values do not fluctuate with ambient conditions are used as the resistors R1, R2, and therefore the stabilized arbitrary reference voltage can easily be obtained with high precision.

In concrete terms, the electric division circuit 13 is provided with the divided number input terminal X and divisor input terminal Y. each of which is a two-input voltage input terminal, and performs calculation by the following equation.

(X/Y)×K=Vo (4)

Here, the voltage E is applied to the divided number input terminal X, and the voltage Vi between the opposite ends of the resistor R2 is applied as a function of the current I to the divisor input terminal Y. That is, the following equation results.

R2×I=Vi (5)

Moreover, the voltage Vi between the opposite ends of the resistor R2 can be represented as a voltage applied to the resistor R2 when the voltage E is divided by the resistors R1, R2 connected in series with each other. That is, the voltage Vi can be represented by the following equation.

E×{R2/(R1+R2)}=Vi (6)

Furthermore, the voltage Vi between the opposite ends of the resistor R2 caused by the flow of the current I is converted to the voltage obtained by dividing the voltage E by a ratio K set by the resistors R1, R2 in the following equation.

{R2/(R1+R2)}=K (7)

Therefore, with X=E, Y=Vi, the reference voltage Vo can be obtained from the division circuit 13 as in the following equation. That is, the values of the resistors R1, R2 are converted to the voltage output.

(E/Vi)×K=Vo (8)

In this case, the division circuit 13 can adjust the outputted reference voltage Vo by changing the ratio K of the equation (8). This means that the ratio of the resistor R1 to the resistor R2 is changed, and that the arbitrary reference voltage Vo can easily be obtained by changing the values of the resistors R1, R2.

That is, in the conventional art, only the voltage determined by the specific element such as Zener diode can be supplied. In the present embodiment, however, the arbitrary reference voltage Vo can easily be obtained only by changing the values of the resistors R1, R2.

Moreover, for example, a resistor having temperature characteristics or resistance value precision of 100 ppm or more is used for the resistors R1, R2. In this case, the reference voltage Vo stabilized to such an extent that the voltage is sufficiently suitable for practical use can be obtained with high precision.

FIG. 2 shows a modification example of the aforementioned embodiment. That is, the reference voltage Vo outputted from the division circuit 13 is amplified at an appropriate level by an amplification circuit 15, and the voltage E to be applied to the resistors R1, R2 is obtained, so that the stable voltage E can be applied to the resistors R1, R2.

Here, the reference power supply apparatus of the present invention can be used alone, but can also be used, for example, as a reference voltage of a constant-voltage power supply apparatus. Moreover, the apparatus can also be a reference power supply of an analog/digital conversion circuit or a digital/analog conversion circuit, and can thus be used as any reference power supply.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reference power supply apparatus comprising:
a resistance element to which a voltage is applied; and
voltage generation means for obtaining a reference voltage corresponding to a resistance value of the resistance element based on the voltage applied to the resistance element.

2. A reference power supply apparatus according to claim 1, wherein said resistance element comprises first and second resistors connected in series to each other, the voltage being applied between the opposite ends of the first and second resistors, and
said voltage generation means generates the reference voltage corresponding to a ratio of the resistance value of the first resistor to the resistance value of the second resistor based on the voltage applied between the opposite ends of said first and second resistors.

3. A reference power supply apparatus according to claim 2, wherein said voltage generation means changes the resistance values of said first and second resistors, and the outputted reference voltage is variable.

4. The reference power supply apparatus according to claim 2 or 3, wherein said voltage generation means comprises a division circuit for dividing the voltage applied between the opposite ends of said first and second resistors by the voltage applied to the opposite ends of said second resistor.

5. A reference power supply apparatus according to claim 1, further comprising feedback means for feeding back the reference voltage generated by said voltage generation means as the voltage to be applied to said resistance element.

6. A reference power supply apparatus comprising:
a series circuit constituted by connecting a first resistor and a second resistor in series with each other; and
a division circuit for dividing a voltage applied between the opposite ends of the series circuit by the voltage between the opposite ends of either one of said first resistor and said second resistor, and generating a reference voltage corresponding to a ratio of a resistance value of said first resistor to the resistance value of the second resistor.

7. A reference power supply apparatus according to claim 6, further comprising an amplification circuit for amplifying the reference voltage generated by said division circuit, and feeding back the reference voltage as the voltage to be applied to said series circuit.

8. A reference power supply apparatus comprising:
a reference level line;
a terminal to which a voltage having a predetermined level difference from the reference level line is applied;
first and second resistors connected in series with each other between the terminal and said reference level line; and
a division circuit for dividing the voltage between the opposite ends of the first and second resistors by the voltage between the opposite ends of said second resistor, and generating a reference voltage corresponding to a ratio of the resistance value of said first resistor to the resistance value of said second resistor.

9. A reference power supply apparatus according to claim 8, further comprising an amplification circuit for amplifying the reference voltage generated by said division circuit, and feeding back the reference voltage as the voltage to be applied to said series circuit.

10. A reference power supply apparatus according to claim 8, wherein a resistor having temperature characteristics of 100 ppm or more is used in said first and second resistors.

11. A reference power supply apparatus according to claim 8, wherein a resistor having a resistance value precision of 100 ppm or more is used in said first and second resistors.
